(19) United States
(12) Patent Application Publication
(10) Pub. No.: US 2010/0310108 A1
(43) Pub. Date: Dec. 9, 2010

(54) CERAMIC EARPHONE SHELL HAVING MULTIPLE FACETS

(76) Inventor: SHIH-YANG CHAN, Tu Cheng City (TW)

Correspondence Address: LEONG C. LEI, PMB # 1008, 1839 YGNACIO VALLEY ROAD, WALNUT CREEK, CA, 94598, US

(21) Appl. No.: 12/477,937

(22) Filed: Jun. 4, 2009

(51) Int. Cl. H04R 25/00

(52) U.S. Cl. 381/380

(57) ABSTRACT

An earphone includes a ceramic shell having an outer surface forming a plurality of facets. The facets reflect lights from different angles to show dazzling and brilliance as a cut gemstone or diamond, providing feeling of beautifulness when worn and increasing competition capability in the market.

### TECHNICAL FIELD OF THE INVENTION

The present invention generally relates to a ceramic earphone shell having multiple facets, wherein an outer surface of a ceramic shell of an earphone is processed to form a plurality of facets, which reflects lights from different angles to show dazzling and brilliance as a cut gemstone or diamond, providing feeling of beautifulness when worn and increasing competition capability in the market.

### DESCRIPTION OF THE PRIOR ART

A conventional earphone is often made as a plug-in type, which allows a user to insert an end of the earphone into an ear but exposes an opposite end of the earphone outside the user's ear. This makes beautifying and decorating the exposed portion of an earphone an important issue especially in respect of enhancing the overall beautifulness of an earphone worn in a user's ear.

The conventional earphone has a shell made of plastics. This makes the manufacturing costs low. However, the plastic earphone shell does not exhibit a glossy and brilliant color and can certainly not show a noble quality. Although the plastic shell can be processed to show a brilliant surface through for example coating or other mirror surface treatment, yet the plastics are a soft material that is susceptible to the formation of scraping marks and peeling of coating, whereby an aged, shabby, and dirty feeling may be perceived. Apparently, improvements are needed in order to remove such a problem.

To address such a need, the present invention aims to provide a ceramic earphone shell with multiple facets to overcome the above discussed problem.

### SUMMARY OF THE INVENTION

A primary objective of the present invention is to provide a ceramic earphone shell having multiple facets, wherein a ceramic shell of an earphone is made to form a plurality of facets on an outer surface thereof in such a way that the facets reflect lights from different angles to show dazzling and brilliance as a cut gemstone or diamond, providing feeling of beautifulness when worn and increasing competition capability in the market.

The present invention provides a ceramic earphone shell having multiple facets, wherein the facets of the shell are converged to a common culet and the facets are arranged to form an umbrella-like configuration. Or alternatively, as shown in FIG. 3, the shell is arranged to form a spherical configuration, and the facets of the shell are lined up and distributed in a circumferential direction on an outer surface of the shell. Or alternatively, as shown in FIG. 4, the facets of the shell are arranged in a multiple-row and alternating fashion on a spherical surface of the shell. However, it is apparent that the arrangement of the facets of the present invention is not limited to the above discussed manner.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an earphone constructed in accordance with the present invention.

FIG. 2 is a perspective view of the earphone of the present invention in an assembled form.

FIG. 3 is a perspective view of the earphone of the present invention showing a different way of arranging facets of a shell of the earphone.

FIG. 4 is a perspective view of the earphone of the present invention showing a further different way of arranging the facets of the shell of the earphone.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

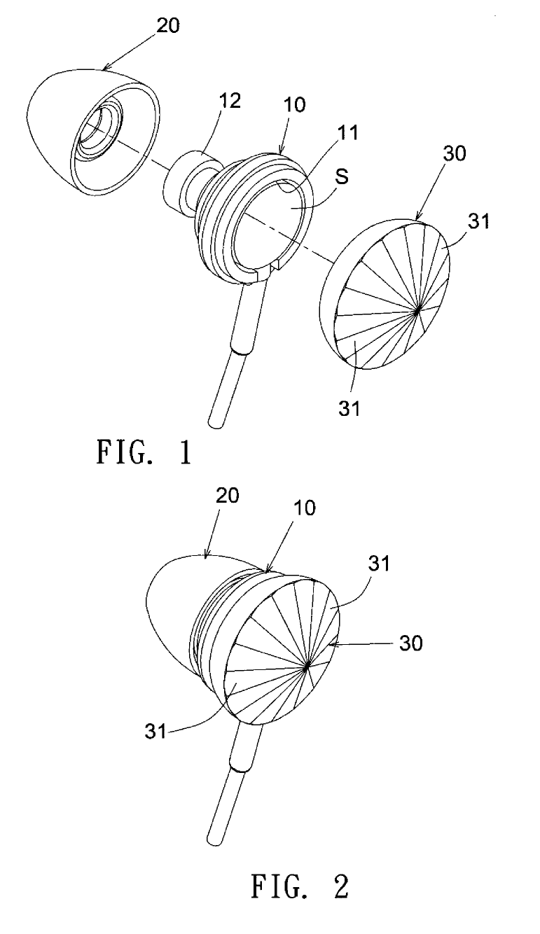

Referring to FIGS. 1 and 2, the present invention provides a ceramic earphone shell having multiple facets. The earphone comprises an inner receptacle 10 that defines a chamber 11 for receiving and retaining a speaker element S. One end of the receptacle 10 forms a projection 12. An earplug 20 is made of rubber materials or the likes and is fit to the projection 12 of the receptacle 10. An outer shell 30 is made of ceramic materials or the likes and is set outside and fixed to the chamber 11 of the receptacle 10 to have the speaker element S housed inside the shell 30 and the receptacle 10. The ceramics made shell 30 has an outer surface that forms a plurality of facets 31, whereby when the earphone is worn in an ear of a user, the shell 30 is exposed outside the ear and the facets 31 reflect lights from different angles to show dazzling and brilliance as a cut gemstone or diamond, providing feeling of beautifulness when worn and increasing competition capability in the market.

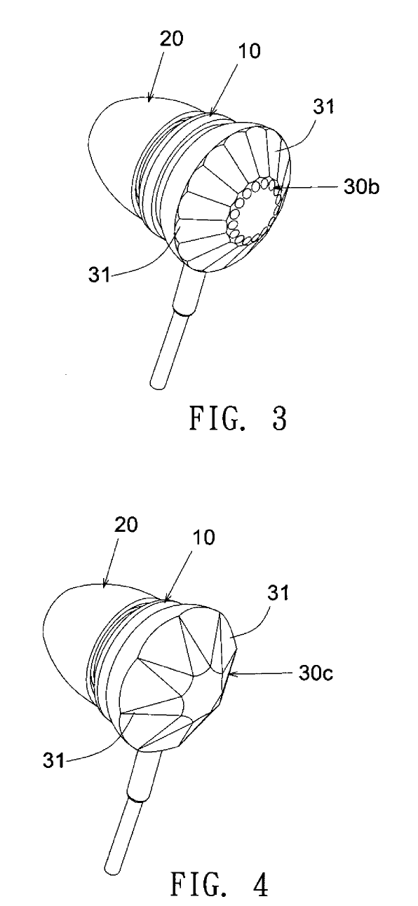

As shown in FIGS. 1 and 2, the present invention provides a ceramic earphone shell having multiple facets, wherein the facets 31 of the shell 30c are converged to a common culet and the facets 31 are arranged to form an umbrella-like configuration. Or alternatively, as shown in FIG. 3, the shell 30b is arranged to form a spherical configuration, wherein the facets 31 of the shell 30b are lined up and distributed in a circumferential direction on an outer surface of the shell 30b. Or alternatively, as shown in FIG. 4, the facets 31 of the shell 30c are arranged in a multiple-row and alternating fashion on a spherical surface of the shell 30b. However, it is apparent that the arrangement of the facets 31 of the present invention is not limited to the above discussed manner.

The present invention provides a ceramic earphone shell having multiple facets. The shell 30, 30b, 30c is made of a ceramic material, such as zirconia or zirconium oxide, but the present invention is not limited to any specific ceramic material making the shell 30, 30b, 30c.

The present invention provides a ceramic earphone shell having multiple facets. Since the shell 30, 30b, 30c is made of a ceramic material, the surface of the shell can be glazed to provide glazing luster. The present invention makes a plurality of facets on the outer surface of the shell 30, 30b, 30c, providing the shell 30, 30b, 30c of the earphone with a visual effect of reflecting lights from different angles and thus enhancing the beautifulness of the product and improving competition capability in the market.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An earphone comprising:
an inner receptacle, which defines a chamber that receives and retains a speaker element;
an ear plug, which is coupled to the receptacle; and
an outer shell, which is made of a ceramic material and is set outside and fixed to the chamber of the receptacle to have the speaker element housed inside the shell and the receptacle;
wherein the shell has an outer surface that forms a plurality of facets.

2. The earphone according to claim 1, wherein the facets are lined up and distributed in a circumferential direction on the outer surface of the shell.

3. The ball according to claim 1, wherein the facets are arranged in a multiple-row and alternating fashion on a spherical outer surface of the shell.

4. The ball according to claim 1, wherein the facets are converged to a common culet and are arranged to form an umbrella-like configuration.
